(19) United States
(12) Patent Application Publication
(10) Pub. No.: US 2024/0403003 A1
(43) Pub. Date: Dec. 5, 2024

(54) BUILDING SOFTWARE APPLICATIONS USING NATURAL LANGUAGE AND MACHINE-LEARNING MODELS

(71) Applicant: Brain Technologies, Inc., San Mateo, CA (US)

(72) Inventors: Sheng Yue, San Mateo, CA (US); Clive Gomes, San Mateo, CA (US)

(21) Appl. No.: 18/680,981

(22) Filed: May 31, 2024

Related U.S. Application Data
(60) Provisional application No. 63/505,698, filed on Jun. 1, 2023.

(51) Int. Cl. G06F 8/34; G06F 8/30

(52) U.S. Cl. CPC G06F 8/34; G06F 8/31

(57) ABSTRACT

A system may receive nodes and edges representing a dynamic-layout software program. The program is represented by nodes and edges, at least one node represents an initial state for an end user to provide an input and at least one edge represents an executable routine whose functionality is specified in a natural language by a software developer. The system executes the initial state of the program at the runtime, receives the input from the end user, and extracts executable elements of the program. The executable elements include the input and the executable routine specified in one of edges. The system applies a machine-learning model to analyze the executable elements to generate a machine-learnable scripting language that connects the executable elements. The machine-learnable scripting language includes runtime layout parameters of the program. When executing the machine-learnable scripting language, the program displays one or more runtime-determined layout elements.

### CROSS-REFERENCE TO RELATED APPLICATION

This application claims the benefit of U.S. Provisional Application No. 63/505,698, filed Jun. 1, 2023, which is incorporated by reference herein in its entirety.

### TECHNICAL FIELD

The present disclosure generally relates to software applications and, particularly, building g software applications using natural language and machine-learning models.

### BACKGROUND

Building software programs for computers requires a wide range of technical skills, which can be quite challenging for individuals due to the specialized nature of these skills. Most people do not possess the diverse set of abilities needed for software development, and even those who do are often experts in only one aspect of coding. For instance, a developer might be highly proficient in web design but not as skilled in backend development or in using specific programming languages like Python or Java. This specialization means that a single person is rarely equipped to handle all the components necessary to create a fully functional application from start to finish.

### SUMMARY

Embodiments are related to building software applications using natural language and machine learning (ML) models. In one embodiment, a system may receive nodes and edges representing a dynamic-layout software program. The dynamic-layout software program is represented by nodes and edges, at least one node represents an initial state for an end user to provide an input and at least one edge represents an executable routine whose functionality is specified in a natural language by a software developer. The system executes the initial state of the dynamic-layout software program at the runtime, receives the input from the end user, and extracts executable elements of the dynamic-layout software program. The executable elements include the input and the executable routine specified in one of edges. The system applies a machine-learning model to analyze the executable elements to generate a machine-learnable scripting language that connects the executable elements. The machine-learnable scripting language includes runtime layout parameters of the dynamic-layout software program. When executing the machine-learnable scripting language, the dynamic-layout software program displays one or more runtime-determined layout elements.

### BRIEF DESCRIPTION OF THE DRAWINGS

Figure (FIG. 1 is a block diagram illustrating an example system environment, in accordance with one or more embodiments.

FIG. 2 is a block diagram graphically illustrating a machine-learnable scripting language, in accordance with one or more embodiments.

FIG. 3 illustrates a process that the executable-routine-providing server determines and executes the scripting language during the runtime of the dynamic layout software program, in accordance with one or more embodiments.

FIG. 4 illustrates a process for building software application using natural language and machine-learning models, in accordance with one or more embodiments.

FIG. 5 is a block diagram graphically illustrating a process for building software application using natural language and machine-learning models, in accordance with one or more embodiments.

FIG. 6A illustrates a process that a software developer provides instructions to design the dynamic layout software program via a build interface, in accordance with one or more embodiments.

FIG. 6B illustrates an example dynamic layout software program during a runtime execution, in accordance with one or more embodiments.

FIG. 7 depicts an example build interface of a dynamic layout software program and the corresponding dynamic user interface, in accordance with one or more embodiments.

FIGS. 8A-8D are diagrams illustrating example graphs of the dynamic layout software program, in accordance with one or more embodiments.

FIG. 9 illustrates a structure of an example neural network is illustrated, in accordance with one or more embodiments.

FIG. 10 is an example machine to read and execute computer readable instructions, in accordance with one or more embodiments.

The figures depict various embodiments for purposes of illustration only. One skilled in the art will readily recognize from the following discussion that alternative embodiments of the structures and methods illustrated herein may be employed without departing from the principles described herein.

### DETAILED DESCRIPTION

The figures and the following description relate to preferred embodiments by way of illustration only. It should be noted that from the following discussion, alternative embodiments of the structures and methods disclosed herein will be readily recognized as viable alternatives that may be employed without departing from the principles of what is claimed.

Reference will now be made in detail to several embodiments, examples of which are illustrated in the accompanying figures. It is noted that wherever practicable similar or like reference numbers may be used in the figures and may indicate similar or like functionality. The figures depict embodiments of the disclosed system (or method) for purposes of illustration only. One skilled in the art will readily recognize from the following description that alternative embodiments of the structures and methods illustrated herein may be employed without departing from the principles described herein.

### Configuration Overview

Disclosed are systems (as well as methods and computer program code stored on non-transitory computer readable media) configured to build software applications using natural language and machine-learning models. The process of developing software involves numerous steps and varied expertise. Each of the steps can require different skill sets and tools. For example, a frontend developer focuses on creating user interfaces and user experiences, using languages and frameworks such as HTML, CSS, and JavaScript. Conversely, a backend developer works on the server side, handling databases, server logic, and application programming interfaces (APIs) with languages like Python, Java, or Node.js. Due to this complexity and the depth of knowledge required in each area, it is exceptionally difficult for one individual to master all these aspects.

While not everyone may possess the technical skills required for software development, most people are proficient in at least one natural language, such as English. Leveraging this universal proficiency, the disclosed configuration allows individuals to build complete systems using natural language and an intuitive workflow. This configuration translates natural language instructions into executable code, which demystifies the software development process, making it accessible to those without technical expertise. It allows users to specify their ideas and requirements as they would in a conversation, and the configuration interprets these instructions to create functional applications. It transforms the process into a more intuitive and accessible workflow, allowing people to convert their thoughts and ideas into executable programs without needing specialized technical skills.

Additionally, the disclosed configuration uses machine learning (ML) models into the process of building software application through natural language interfaces. The ML models enhance the accuracy and efficiency of translating natural language instructions into executable code. The ML models can automate repetitive and routine coding tasks, significantly reducing the development time as well as maintaining consistency and reducing errors in code generation. Furthermore, incorporating ML models facilitates real-time learning and adaptation. As users interact with the system, the ML models generate scripting language during the runtime. The software application may be continuously improved by learning from user inputs and feedback. The integration of ML models into the natural language-based software development makes the process more accessible, efficient, and responsive, empowering users to turn their ideas into functional applications with ease.

### Example System Configuration

Figure (FIG. 1 is a block diagram that illustrates a software building system environment 100, in accordance with one or more embodiments. The system environment 100 includes a software builder server 110, a dynamic layout software program 120, an executable-routine-providing server 130, a software developer device 140, an end user device 150, a scripting language determination machine learning (ML) model 160, a network 170, and a data store 180. The entities and components in the system environment 100 communicate with each other through the network 170. In various embodiments, the system environment 100 includes fewer or additional components. In some embodiments, the system environment 100 also includes different components. While each of the components in the system environment 100 is described in a singular form, the system environment 100 may include one or more of each of the components. Different end user devices 130 and software developer devices 140 may also access the dynamic layout software program 150 simultaneously.

The software builder server 110 includes one or more computers that host a natural-language software builder 112 for developers to build software in natural language. The software builder server 110 may perform various tasks, such as compiling software designed by different customers using the natural-language software builder 112 and testing the software. In some embodiments, the software builder server 110 may receive designs from various clients (e.g., software developers) of the software builder server 110 and builds corresponding software based on the designs. One or more software built may include dynamic user interfaces 152 that have user interfaces changed at runtime based on the end users' commands. The software builder server 110 may use a scripting language and a scripting language determination ML model 160 to generate the software based on a client's design in a manner that will be further discussed in this disclosure.

In some embodiments, the software builder server 110 may include a natural-language software builder 112 configured to display a build interface that allows a software developer to design software such as a dynamic-layout software program 120. The natural-language software builder 112 provides a tool or platform that allows software developers to build software using natural language. Instead of writing code directly, software developers may interact with the natural-language software builder 112 using natural language via the software developer device 140, and the natural-language software builder 112 converts these natural language commands into executable code. The natural-language software builder 112 may use natural language processing (NLP) and machine learning techniques to understand and interpret user intent, generate code, and handle various programming tasks such as identifying preexisting applicable routines, creating functions, defining variables, or implementing logic. In some embodiments, the natural-language software builder 112 may access an executable routine providing server 130 which hosts one or more existing routines, such as microservices, pre-written software module, and software applications. The natural-language software builder 112 receives and executes the scripting language to build the dynamic layout software program 120. The natural-language software builder 112 may use a machine learnable scripting language to provide the layout parameters of the dynamic-layout software program 120. The layout parameters may be associated with runtime-determined layout elements defining the format, position, user interface, etc. of the dynamic layout software program 120. The natural-language software builder 112 simplifies the software development process, making it more accessible to non-programmers and reducing the need for low-level coding.

A dynamic layout software program 120 is a software program that is designed by a software developer for end users' use. In one embodiment, a dynamic layout software program 120 is generated based on a design specified in the natural-language software builder 112. The dynamic layout software program 120 may not have a fixed user interface layout. In some cases, the dynamic layout software program 120 does not determine its layout until at runtime where an end user provides an input or a command and the dynamic layout software program 120 determines the intent of the end user and the types of routines that need to be carried by based on the intent.

In one implementation, the design of a dynamic layout software program 120 may include nodes and one or more edges that connect the nodes. The nodes and edges may represent executable elements, such as, input data, output data, executable routines, etc. The dynamic-layout software program 120 may include layout parameters that define the format of the input data and/or the output data. Each node may represent a state of a data signal. The data signal may include text, image, links, audio, video signals, etc. A software developer may specify the nodes and edges at the natural-language software builder 112 to design a dynamic layout software program 120.

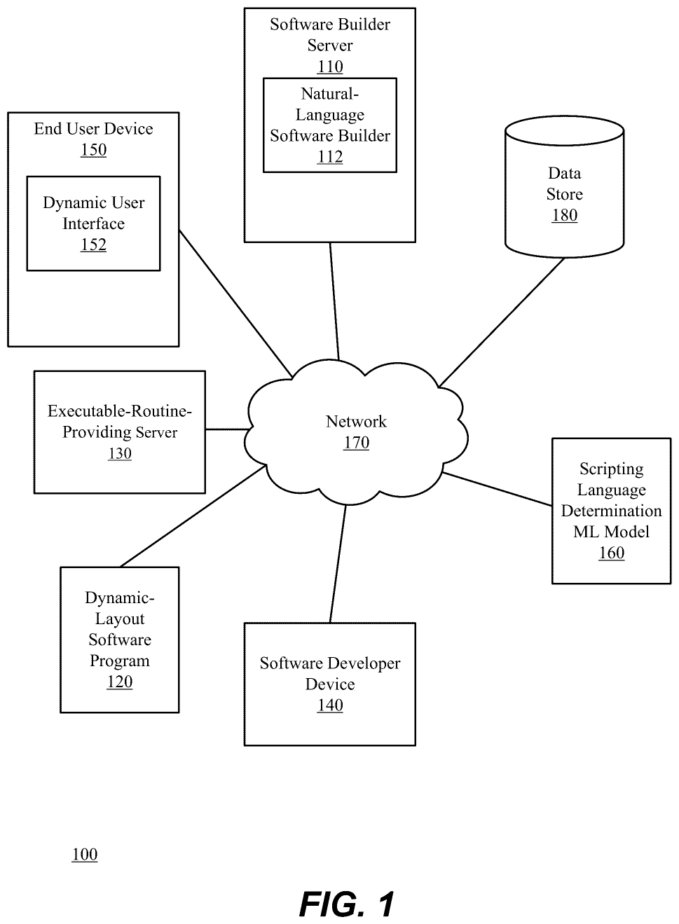

The dynamic layout software program 120 may include a node representing an initial state for an end user to provide an input, e.g., a state that receives a first user input. The dynamic-layout software program 120 may include a node representing an end state for presenting a response to the input to the end user. An edge may represent an executable routine whose functionality is specified in a natural language by a software developer. In one example, an edge may connect between a precedent node (e.g., an input node) and a subsequent node (e.g., an output node). The input node may be configured to receive data input from an end user and the output node may be configured to present a response to the data input to the end user. The executable routine may be an action that can be performed on the data input to generate the response, e.g., transforms the data input to the data output. The software developer may specify the corresponding action at the edge using natural language. For example, an input node is configured to receive an image, the executable routine represented by an edge is configured to convert the image into text, and the corresponding output node is configured to represent the converted text. The functionality of the executable routine is “image to text conversion,” the corresponding natural language description may vary depending on the software developers' input instruction. For instance, the corresponding natural language may be: “describe the image in text,” “list the items in the image,” “provide descriptions of the items in the image,” and the like. In another example, only one end of an edge may be connected to a node. For example, a dynamic-layout software program 120 may start with a greeting to the end user. In this case, the dynamic-layout software program 120 may start with an edge that is described as “provide a greeting to a user,” and the edge connects to an output node which is configured to present the greeting. The dynamic-layout software program 120 may provide a dynamic user interface 152 at an end user device 150 for the end user to input data into the dynamic layout software program 120 and receive output response from the dynamic layout software program 120. Examples of are discussed in further details below with reference to FIGS. 2-10.

The system environment 100 may include one or more executable-routine-providing servers 130. An executable-routine-providing server 130 may be a third-party server that is made available to the software builder server 110. The executable-routine-providing server 130 may include various routines such as pre-built software applications (e.g., a music player, a digital map, a stock trading platform), software modules, machine-learning models (e.g., a large language model (LLM)) and/or microservices (identity service, transaction service, etc.) that are available for the software builder server 110 to use. When the software builder server 110 executes a dynamic layout software program 120, the software builder server 110 may identify routines that are specified in edges of the design to identify what types of software routines need to be run in the dynamic layout software program 120. In turn, the software builder server 110 may execute one or more application programming interface (API) calls to request for routines that are hosted at one or more executable-routine-providing servers 130 to be executed.

A software developer device 140 is a computing device that belongs to a software developer. The software developer device 140 may be a computer or computing device that software developers use for design software, such as design a dynamic layout software program 120 using the natural-language software builder 112. In one implementation, the software developer device 140 may communicate with the software builder server 110, which hosts the natural-language software builder 112. The software developer device 140 may receive input from the software developer via the natural-language software builder 112, and the input may include tasks/commends/instructions from the software developer on building the dynamic layout software program 120. For example, the instructions may specify the functionality of an executable routine in a natural language. The software builder server 110 receives the design from the software developer device 140. The design includes nodes and edges of the dynamic layout software program 120. In some embodiments, based on the design specified at the natural-language software builder 112, the software builder server 110 may build a dynamic layout software program 120 that includes at least one node representing an initial state for an end user to provide an input and at least one edge representing an executable routine whose functionality is specified in a natural language by the software developer.

An end user may be the customers of a software developer and may be the end user of the dynamic layout software program 120 that is designed by the software developer. An end user may enter user input directed at the dynamic layout software program 120 via a dynamic user interface 152 at an end user device 150. The end user device 150 can be any personal or mobile computing devices such as smartphones, tablets, notebook computers, laptops, desktop computers, and smartwatches as well as any home entertainment device such as televisions, video game consoles, television boxes, receivers, or any other suitable electronic devices. The software builder server 110 can present information received from executing the dynamic layout software program 120 to an end user, for example in the form of user interfaces (e.g., the dynamic user interface 152). The end user device 150 may communicate with the dynamic layout software program 120 via the network 170.

The end user device 150 may include a dynamic user interface dynamic user interface 152, which receives input and displays output for the dynamic layout software program 120. The dynamic user interface 152 may be a suitable interface for an end user to interact with the dynamic layout software program 120. For example, the dynamic user interface 152 may receive an end user input to an initial state of the dynamic layout software program 120 and the software builder server 110 may extract executable elements using at least the user input and generate a scripting language for the dynamic layout software program 120.

The dynamic user interface 152 may take different forms. In one embodiment, the dynamic user interface 152 may be an interface displayed within a web browser such as CHROME, FIREFOX, SAFARI, INTERNET EXPLORER, EDGE, etc. and the dynamic layout software program 120 may be a web application that is run by the web browser. In one embodiment, the dynamic user interface 152 is part of the application that is install in the end user device 150. For example, the end user device 150 may be the front-end component of a mobile application or a desktop application. In one embodiment, the dynamic user interface 152 is a graphical user interface (GUI) which includes graphical elements and user-friendly control elements.

The scripting language determination ML model 160 is a machine-learning model that analyzes the executable elements to generate a machine-learnable scripting language that connect the executable elements so that the executable elements form part of the dynamic layout software program 120. The software builder server 110 may apply the scripting language determination ML model 160 to the executable elements and generate the machine-learnable scripting language in the runtime of the dynamic layout software program 120. The generated machine-learnable scripting language connects the executable elements and includes the runtime layout parameters of the dynamic layout software program 120.

The network 170 provides connections to the components of the system environment 100 through one or more sub-networks, which may include any combination of local area and/or wide area networks, using both wired and/or wireless communication systems. In one embodiment, a network 170 uses standard communications technologies and/or protocols. For example, a network 170 may include communication links using technologies such as Ethernet, 802.11, worldwide interoperability for microwave access (WiMAX), 3G, 4G, Long Term Evolution (LTE), 5G, code division multiple access (CDMA), digital subscriber line (DSL), etc. Examples of network protocols used for communicating via the network 170 include multiprotocol label switching (MPLS), transmission control protocol/Internet protocol (TCP/IP), hypertext transport protocol (HTTP), simple mail transfer protocol (SMTP), and file transfer protocol (FTP). Data exchanged over a network 170 may be represented using any suitable format, such as hypertext markup language (HTML), extensible markup language (XML), JavaScript object notation (JSON), structured query language (SQL). In some embodiments, some of the communication links of a network 170 may be encrypted using any suitable technique or techniques such as secure sockets layer (SSL), transport layer security (TLS), virtual private networks (VPNs), Internet Protocol security (IPsec), etc. The network 170 also includes links and packet switching networks such as the Internet.

The data store 180 includes one or more computing devices that include memories or other storage media for storing various files and data of the software builder server 110, and/or the executable-routine-providing server 130. For example, the data store 180 stores software developer data, end user data for use by the software builder server 110 and the executable-routine-providing server 130. The data store 180 also stores trained machine-learning models trained included in the scripting language determination ML model 160. For example, the data store 180 may store the set of parameters for a trained machine-learning model on one or more non-transitory, computer-readable media. The data store 180 uses computer-readable media to store data, and may use databases to organize the stored data.

In various embodiments, the data store 180 may take different forms. In one embodiment, the data store 180 is part of the software builder server 110 and/or the executable-routine-providing server 130. For example, the data store 180 is part of the local storage (e.g., hard drive, memory card, data server room) of the software builder server 110 and/or the executable-routine-providing server 130. In some embodiments, the data store 180 is a network-based storage server (e.g., a cloud server). The data store 180 may be a third-party storage system such as AMAZON AWS, DROPBOX, RACKSPACE CLOUD FILES, AZURE BLOB STORAGE, GOOGLE CLOUD STORAGE, etc.

Various servers in this disclosure may take different forms. In one embodiment, a server is a computer that executes code instructions to perform various processes described in this disclosure. In another embodiment, a server is a pool of computing devices that may be located at the same geographical location (e.g., a server room) or be distributed geographically (e.g., clouding computing, distributed computing, or in a virtual server network). In one embodiment, a server includes one or more virtualization instances such as a container, a virtual machine, a virtual private server, a virtual kernel, or another suitable virtualization instance.

The software builder server 110 may include one or more processors and memory that are configured to provide a scripting language for executing the dynamic-layout software program 120. In some embodiments, the executable-routine-providing server 130 may generate the scripting language at runtime of the dynamic layout software program 120. The scripting language may connect the executable elements and include runtime layout parameters of the dynamic layout software program 120. The executable-routine-providing server 130 may provide the scripting language to the software builder server 110 to cause the dynamic layout software program 120 to display one or more runtime-determined layout elements.

### Machine-Learnable Scripting Language

FIG. 2 is a conceptual diagram illustrating a machine-learnable scripting language 200, in accordance with one or more embodiments. As shown in FIG. 2, the machine-learnable scripting language 200 may connect various executable elements in a dynamic layout software program 120. The executable elements may be extracted from the natural language that describes the executable routines 202, and/or an end user input 204. The executable elements may include the actions/functions associated with the executable routines 202, the data signals included in the end user input 204, and/or the layout elements 206 determined based on the executable routines 202 and end user input 204. Some executable routines 202 may be represented by the edges in the dynamic layout software program 120 and the end user input 204 may refer to the input from an end user that is directed to the dynamic layout software program 120. The software builder server 110 generates the machine-learnable scripting language 200 that enables the dynamic layout software program 120. In some embodiments, the machine-learnable scripting language 200 may specify layout elements 206 to be displayed in the dynamic layout software program 120.

Executable routines 202 may be associated with segments of code that perform specific tasks or operations within a software program. In some embodiments, an executable routine 202 may be specified in an edge by the software developer in natural language, describing the action to be performed on the data signal. For example, an executable routine 202 may be specified in an edge of the dynamic layout software program 120, e.g., “translate the input from Chinese to English,” “list the items in the input image,” etc. The executable routines 202 may perform calculations, manipulate data, interact with computing systems/user interface, or execute other operations necessary for the software program's functionality. In some implementations, the software builder server 110 may break down a software program into smaller, manageable executable routines 202, and each executable routine 202 is associated with an edge in the dynamic layout software program 120. In some implementations, the dynamic layout software program 120 may group one or more executable routines 202 and form a cluster of executable routines 202 (e.g., a building block of edges.) The cluster of executable routines 202 may be stored and retrieved for building software applications. In some embodiments, some of the executable routines 202 may be readily available from a third party. The software builder server 110 may identify those readily available routines and execute one or more API calls to an executable-routine-providing server 130 to execute the routines. For example, an executable routine 202 may be identifying an animal in a picture uploaded by the end user. A convolutional neural network (CNN) that is provided by an executable-routine-providing server 130 may be readily available. Instead of compiling or generating a new model, the software builder server 110 may identify the CNN made available by the executable-routine-providing server 130 and make an API call. The identification of what existing tools is available may be performed by applying the scripting language determination ML model 160 in generating the scripting language 200. For example, the scripting language 200 may include the API call and the parameters in the API call.

The end user input 204 includes the input from the end user that is directed at the dynamic-layout software program 120, e.g., request, query, etc. When receiving an end user input 204, the dynamic layout software program 120 may extract executable elements based in part on the end user input 204. For example, the end user input 204 may be a user query, e.g., “what are some top stock picks for the upcoming quarter?” The dynamic layout software program 120 may extract “top stock,” “pick,” “upcoming quarter,” as executable elements, and use the extracted executable elements to generate the machine-learnable scripting language 200.

The layout elements 206 may refer to components used in designing the structure and appearance of the data signals represented by the nodes in the dynamic layout software program 120. For example, the layout elements 206 may include text blocks, images, and media elements that display content, while buttons and controls offer interactivity. The layout elements 206 may include navigation elements like menus, navbars, sidebars, and tabs that guide end users through different parts of the dynamic layout software program 120. The layout elements 206 may include various other components for creating structured, visual, and functional interfaces that enhance user experience by making content easy to access and interact with.

In some embodiments, the dynamic layout software program 120 may determine the layout elements 206 based on the extracted executable elements, and the generated machine-learnable scripting language 200 may include layout parameters that specify the layout elements 206. Layout parameters may be used to define the positioning, sizing, and arrangement of the layout elements 206. The layout elements 206 may include positioning attributes (e.g., left, right, top, bottom, etc.), sizing parameters (e.g., width and height), alignment parameters which control how elements align within a container, and the like.

The executable elements in running a dynamic layout software program 120 may include various components. For example, the executable elements may include an executable routine 202 may be associated with an “image to text conversion” function. The executable elements may also include an end user input 204, which may include the image input by the end user. The executable elements may further include an actual software routine that is able to perform “image-to-text conversion,” such as a machine-learning model that is provided by an executable-routine-providing server 130. The executable elements may further include layout elements 206, such as how the text that describes the image is positioned relative to the image. These example executable elements are individual elements that are not always connected in the code level. The machine-learnable scripting language 200 serves as the connecting language to connects the executable elements together to form part of the dynamic layout software program 120.

Since the edges of the dynamic layout software program 120 may be described in a natural language, in another example, the edge of the dynamic layout software program 120 may be “list the items in the image.” The corresponding executable elements may include the image input by the end user, the function of “image-to-text conversion,” and a format of the output data, e.g., the output data is in a format of a list. The corresponding machine-learnable scripting language 200 may include a text block in a list format (e.g., an example of a layout element 206). In some implementations, the dynamic layout software program 120 may determine the layout parameters directly based on the extracted executable elements; and in some implementations, the dynamic layout software program 120 may apply a machine-learning model (e.g., a scripting language determination ML model 160) to determine the layout parameters.

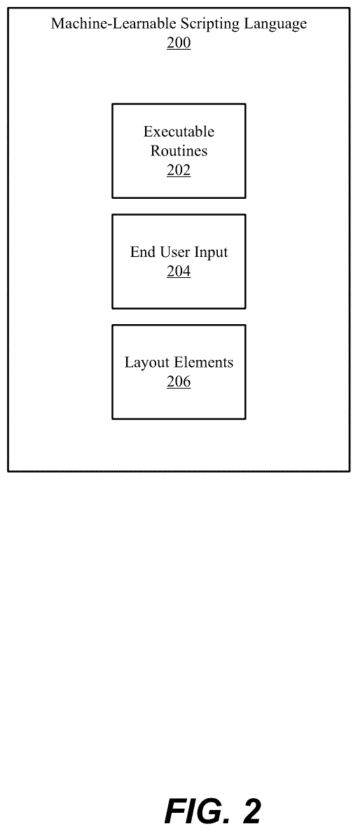

FIG. 3 illustrates a block diagram illustrating a process 300 on how the scripting language may be dynamically generated during the runtime of the dynamic layout software program 120, in accordance with one or more embodiments. The software builder server 110 may receive 312 the nodes and edges that represent the dynamic layout software program 120. The dynamic layout software program 120 may be at an initial state. In some embodiments, the software builder server 110 may initialize the dynamic layout software program 120 with the nodes and edges before receiving an end user input. When the software builder server 110 receives 302 runtime end user input that is directed at the dynamic layout software program 120 (e.g., the end user inputs a query or a command into the dynamic layout software program 120), and the software builder server 110 extracts 304 executable elements from the dynamic layout software program 120 based on the runtime user input 302 and/or the nodes and edges of the dynamic layout software program 120. As the end user provides input data to the dynamic layout software program 120 during the runtime, the software builder server 110 may generate the scripting language in real time. The generated scripting language may vary depending on the received input data from the end user during the runtime of the dynamic layout software program 120.

The scripting language may be a type of programming language that include sequences of commands executed by an interpreter or runtime environment rather than compiled into machine code. The scripting language may be interpreted at runtime, and the source code is translated into machine code line-by-line as the dynamic layout software program 120 runs. The scripting language may include dynamic typing, where variable types are determined at runtime, and come with built-in functions and libraries to facilitate common tasks such as string manipulation, network communication, and the like.

In some implementations, the software builder server 110 may apply 306 a machine-learning model (e.g., a scripting language determination machine-learning model 160) to analyze the extracted executable elements and/or the nodes and edges of the dynamic layout software program 120 to generate 308 the scripting language. In some embodiments, since part of the scripting language is generated by a machine-learning model, the scripting language may also be referred as machine learnable scripting language. A machine learnable scripting language incorporates machine learning capabilities into its syntax or libraries, making it easier for software developers to implement machine learning algorithms and models. For example, the machine learnable scripting language may include built-in libraries or code segments specifically designed for machine learning tasks, such as functions for training models, data preprocessing, and model evaluation. The machine learnable scripting languages may integrate with common machine learning data structures, algorithms, and tools, facilitating interoperability with other frameworks.

In some embodiments, the executable elements may include an executable routine that is specified in one of the edges of the dynamic layout software program 120. The software builder server 110 may generate an input to the scripting language determination ML model 160. The generated input includes the executable elements and a request to generate a scripting language that performs the executable routine with the executable elements. The executable routine may be a task that can be performed on a data signal (e.g., an executable element). For example, the tasks may include, but are not limited to, natural language processing (NLP) tasks, audio processing tasks, image processing tasks, video processing tasks, and the like. The NLP tasks may include, but are not limited to, text generation, image generation, audio generation, video generation, query processing, machine translation, chatbots, and the like. The output includes a scripting language that can be executed by the software builder server 110 to perform the executable routines, e.g., tasks. Some of the tasks can be performed by readily available preexisting software (e.g., playing music, determining a map location, sending an email). Those preexisting software may be provided by the executable-routine-providing server 130.

In some embodiments, the executable elements include a user input (e.g., text data, audio data, image data, or video data) from the end user directed at the dynamic layout software program 120. The executable routines are translated from edge intents in a natural language. The software builder server 110 applies the scripting language determination ML model 160 to the edge intents to determine part of the executable routines. For example, the scripting language determination ML model 160 encodes the edge intents into a set of input tokens and generates a scripting language as an output.

In some embodiments, part of a scripting language for executing an executable routine may be pre-generated and stored in a database (library). The software builder server 110 may identify and select the scripting language based on the executable elements from the database during runtime of the dynamic layout software program 120. For example, each executable routine may be associated with a scripting language stored in the database. Each scripting language is associated with the natural language that describes the executable routine. The software builder server 110 may determine the scripting language based on the natural language that describes the executable routine. In some examples, after a scripting language has been generated based on the natural language of the executable routine, it can be run with different inputs to get corresponding outputs.

In some embodiments, the scripting language determination ML model 160 may include an NLP model that elaborates the natural language of the executable routine in an edge of the dynamic layout software program 120. For example, the NLP model may generate a set of sub-executable routines that together performs the executable routine specified in the natural language, the layout parameters of the output (whether the end result is text, an image, etc.), and natural language descriptions for what tools are needed for the executable routine. The NLP model may apply a semantic similarity analysis to the natural language description of the executable routine and determine a set of candidate pre-stored scripting languages based on the natural language description. The NLP model may determine the closest pre-stored scripting language by comparing the natural language descriptions of the executable routine and the candidate pre-stored scripting languages.

In some implementations, the pre-stored scripting language may be modified/fine-tuned based on the user history, user preference, and/or other executable elements (e.g., the end user input) that are extracted with the executable routine. In some cases, a pre-stored scripting language may be associated with a specific executable routine that has predetermined inputs/outputs in specific formats. For example, a generic question-answering language script may be fine-tuned to be better at answering certain kinds of questions by providing the scripting language determination ML model 160 with the extracted elements. After fine-tuning, the input/output connections from all the scripting languages are appropriately linked together, with the main input(s) and output being connected to the nodes of the dynamic layout software program 120.

For example, a software developer may define an input node to receive an image of a menu from an end user. The input node connects to an edge with a natural language description, “rank the items in the image based on their nutrition scores.” In this case, the scripting language may correspond to a set of sub-executable routines, e.g., a scripting language that performs image to text transformation, a scripting language that performs text analysis to identify dish name and ingredients, a scripting language that retrieves nutrition information for each dish and ingredient, a scripting language that ranking the dishes based on their nutrition scores, etc. The scripting languages correspond to the set of sub-executable routines may be combined and form an overall scripting language, when executed, performs the executable routine, “rank the items in the image based on their nutrition scores,” on the end user input. The overall scripting language may be packaged, stored, retrieved by the software builder server 110. In some embodiments, the software builder server 110 may retrieved the overall scripting language and update it with the received end user input during the runtime of the dynamic layout software program 120. In some embodiments, the software builder server 110 does not need to identify the overall scripting language each time during the runtime unless the software developer updates the natural language description or provides feedback.

In some embodiments, the scripting language determination ML model 160 may be retrained/updated based on feedback. In some embodiments, feedback may be added to the natural language description of the executable routine to modify/improve its functionality. In some embodiments, feedback may be provided to modify the underlying connections of the executable elements. For an over scripting language that corresponds to a set of sub-executable routines, feedback may be provided for a specific output (in the set) or to the entire output as a whole.

In some embodiments, the scripting language determination ML model 160 may be stored/deployed in a database of the software builder server 110. Alternatively, the scripting language determination ML model 160 may be stored/deployed in a server that is different from the software builder server 110. For example, the scripting language determination ML model 160 may be deployed on an infrastructure configured with, for example, supercomputers that provide enhanced computing capability (e.g., graphic processor units) for training or deploying deep neural network models. In one instance, the scripting language determination ML model 160 may be trained and deployed or hosted on a cloud infrastructure service. The scripting language determination ML model 160 may be pre-trained by the software builder server 110 or one or more entities different from the software builder server 110. The scripting language determination ML model 160 may be trained on a large amount of data from various data sources. For example, the data sources include websites, articles, posts on the web, and the like. From this massive amount of data coupled with the computing power of the scripting language determination ML model 160. The software builder server 110 is able to generate a scripting language that executes various executable routines and synthesize and formulate output responses based on information extracted from the training data.

The software builder server 110 executes 310 the generated scripting language, which includes various executable elements illustrated in FIG. 2 that are appropriately connected by the scripting language. The execution of the dynamic layout software program 120 displays one or more layout elements to the end user. The layout elements may include the results of the executable routines executing on the end user input, e.g., a query result, output data of a function, result of a task, etc. In some embodiments, the runtime execution 310 of the dynamic layout software program 120 may cause the end user to provide further input 302 to the dynamic layout software program 120, and the software builder server 110 proceed to another round of generating and executing scripting language for the dynamic layout software program 120. For example, the first round of scripting language may be “Translate Chinese content into English,” the second round of scripting language may be “Generate a picture illustrating the translated content,” the third round of scripting language may be “Change the color of item XYZ in the picture to purple,” and so on. The scripting language generation and execution may be continued/looped until the end user stops inputting further instructions and/or the software builder server 110 identifies an executable routine that ends the dynamic layout software program 120.

### Software Application Building Process

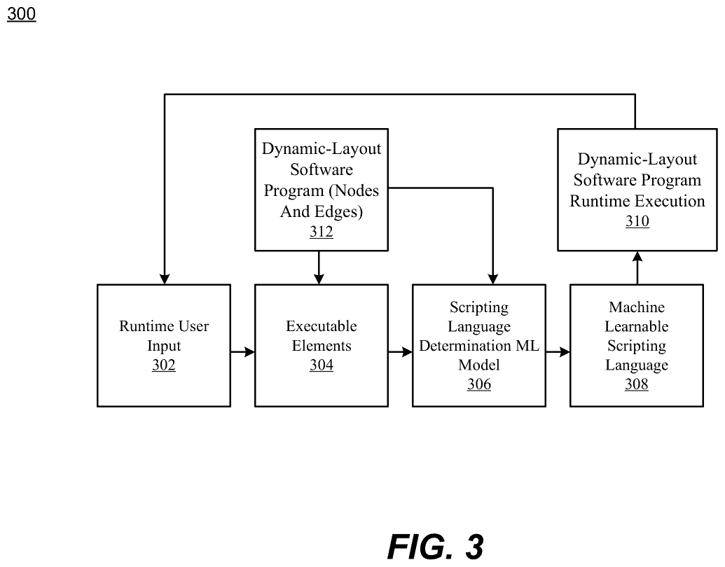

FIG. 4 illustrates a process 400 for building software application using natural language and machine-learning models, in accordance with one or more embodiments. For the particular embodiment discussed in FIG. 4, the software builder server 110 and the executable-routine-providing server 130 are different servers and operate independently. For example, the software builder server 110 includes one or more computers. A computer associated with the software builder server 110 includes a first processor and first memory. The first memory stores a first set of code instructions that, when executed by the first processor, causes the first processor to perform some of the steps described in the process 400. The executable-routine-providing server 130 uses different hardware and includes a different computer (or one or more computers) that includes a second processor and second memory. The second memory stores a second set of code instructions that are different from the first set of code instructions. For example, the second set of code instructions may be developed independently using even a different programming language. The second set of code instructions, when executed by the second processor, cause the second processor to perform other steps described in the process 400. While two independent servers are described as an example architecture associated with the process 400, in some embodiments a single server can also perform the entire process 400.

A software builder server 110 may receive 402 a request to build a dynamic layout software program 120 from a software developer device 140. The software builder server 110 may provide a build interface at the software developer device 140 for receiving the request from a software developer. The request may include commands on building the dynamic layout software program 120. In some embodiments, the software build server 110 may include a natural-language software builder that allows a software developer to design a dynamic-layout software program with commands in a natural language. In some embodiments, the dynamic layout software program 120 is represented by nodes and one or more edges. The software builder server 110 determines 404 nodes and edges that are included in the dynamic layout software program 120 based on the received software developer's request. In one example, the dynamic layout software program 120 may start with a node; alternatively, the dynamic layout software program 120 may start with an edge.

In some embodiments, the software builder server 110 may be in communication with the natural-language software builder 112 that receives the determined nodes and edges representing the dynamic layout software program 120 from the software builder server 110. In one implementation, the software builder server 110 and natural-language software builder 112 may be located at a same server; alternatively, the software builder server 110 and natural-language software builder 112 may be located at different servers and/or operated separately.

The software builder server 110 executes 406 a state of the dynamic-layout software program 120 at runtime of the dynamic layout software program 120. For example, the software builder server 110 may initialize the dynamic layout software program 120 before receiving an input from an end user. In one implementation, the dynamic layout software program 120 may include at least one node that represents an initial state for an end user to provide an input, e.g., a state that receives a first user input. In another implementation, the dynamic layout software program 120 may include at least one edge representing an executable routine whose functionality is specified in a natural language by the software developer.

The software builder server 110 receives 408 an input from an end user directed at the dynamic-layout software program 120. The end user may input a request/query/task to the dynamic layout software program 120 via a dynamic user interface at the end user device 150. The software builder server 110 may extract 410 executable elements of the dynamic layout software program 120. The executable elements may include the input from the end user and at least one executable routine specified in one of edges.

The software builder server 110 applies 412 a machine-learning model to generate a scripting language that connects the executable elements. The generated scripting language may be executed to perform the functionality associated with the at least one routine specified in an edge. The generated scripting language may be a machine-learnable (ML) scripting language. In some embodiments, the executable elements may be specified in a natural language, and the machine-learning model may be applied to analyze the executable elements in the natural language. In some implementations, the software builder server 110 may generate the ML scripting language during the runtime of the dynamic-layout software program 120. In some implementations, the ML scripting language may include runtime layout parameters of the dynamic-layout software program 120. In some examples, the generated scripting language may correspond to various routines that are provided by the executable-routine-providing server 130, such as pre-built software applications (e.g., a music player, a digital map, a stock trading platform), software modules, machine-learning models (e.g., a large language model (LLM)) and/or microservices (identity service, transaction service, etc.) that are available for the software builder server 110 to use. The generated scripting language may correspond to routines that are specified in edges of the design and identify what types of software routines need to be run in the dynamic layout software program 120.

The software builder server 110 receives the ML scripting language from the ML model, and executes 414 the ML scripting language during the runtime of the dynamic layout software program 120. When the software builder server 110 executes a dynamic layout software program 120, the software builder server 110 may execute one or more application programming interface (API) calls to request for routines that are hosted at one or more executable-routine-providing servers 130 to be executed.

In some embodiments, executing the ML scripting language causes the dynamic layout software program 120 to display one or more runtime-determined layout elements. The layout elements may include as a result of executing the function of an executable routine on at least one executable elements. The layout elements may be determined based on the end user input, and/or recommended by the ML model based on the semantic understanding of the description for executable routines. In some embodiments, the displayed layout elements may include a visual design that is specified by the layout parameters. In some embodiments, the layout elements may include user interface elements. In some embodiments, the layout elements may be displayed in the dynamic user interface at the end user device 150.

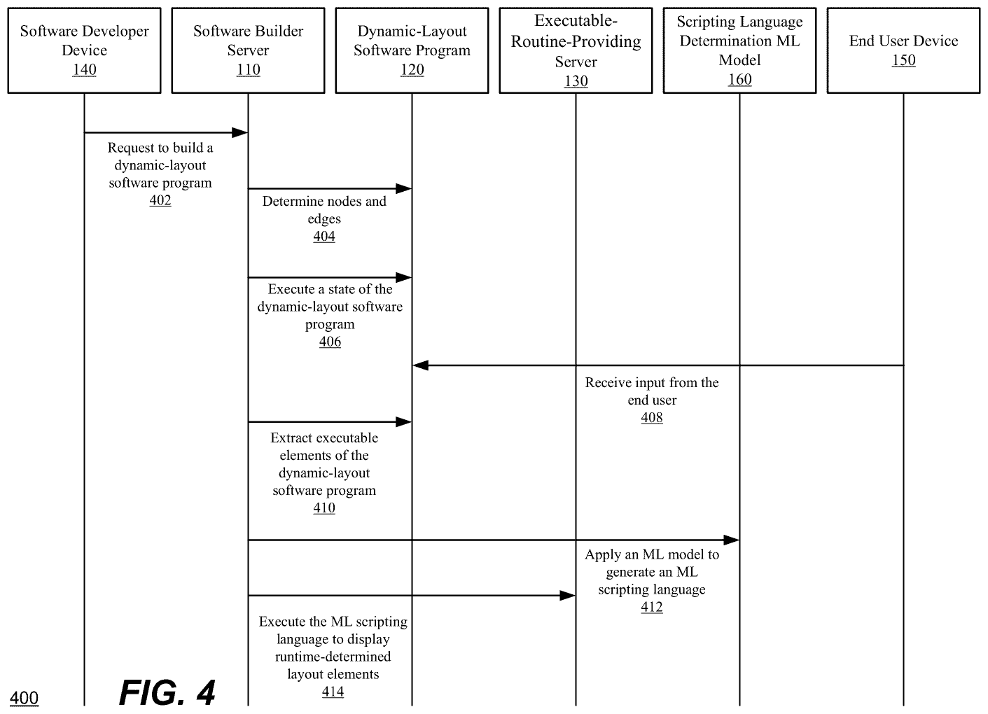

FIG. 5 is a block diagram graphically illustrating a process for building software application using natural language and machine-learning models, in accordance with one or more embodiments. FIG. 5 illustrates a front-end process 500 in which software developers/end users can see and a back-end process 550 in which software developers/end users do not see. The front-end process 500 may be interactable/viewable via a user interface (build interface) provided by the natural-language software builder 112 and the back-end process 550 may be performed by the natural-language software builder 112 that is not viewable to the software developer. In some embodiments, the front-end process 500 may include a user interface for displaying the dynamic layout software program to the software developers/end users. For example, the user interface may be a build interface displayed to the software developers at the software developer devices 140. Alternatively, the user interface may be a dynamic user interface 152 displayed to the end users at the end user device 150.

As shown in FIG. 5, in the front-end process 500, the software developer may provide a developer instruction 512 to the software builder server 110 via a build interface of a natural-language software builder 112. The developer command 512 may include commands on building the dynamic layout software program. The software developer may build the software program 518 with parameters in various dimensions. For example, the dimensions may include a design dimension 502, a data dimension 504, and an action dimension 506. The design dimension design dimension 502 may refer to the view of the nodes/edges in the software program 518. In some implementations, the design dimension 502 may specify the runtime layout elements in the software program 518. The developer instruction 512 may include layout parameters to specify the design dimension 502 of the software program 518. In some embodiments, the natural-language software builder 112 may provide a user interface (UI) repository 520 which includes various UI components, such as, text box, display components, interactive user interface element, etc. The software developer/end user may select UI components from the user interface repository 520.

The data dimension 504 may refer to the content of the data signal that is represented by a node in the software program 518. The action dimension 506 may refer to the executable routine that is represented by an edge in the software program 518. The developer instruction 512 and the parameters in the three dimensions may be specified in a natural language. The software builder server 110 builds the software program 518 based on the developer instruction 512. In some embodiments, the software program 518 may receive the end user input 514 and the end user interaction 516 during runtime of the software program 518. The received end user input 514 and software program 518 may include executable elements in the three dimensions, e.g., design dimension 502, data dimension 504, and/or action dimension 506. The executable elements may be extracted to generate the software program 518 during runtime.

The back-end process 550 illustrates the process of generating scripting language 528 by the software builder server 110. As shown in FIG. 5, the software builder server 110 receives extracted executable elements from the front-end process 500 and uses the executable elements to generate the scripting language 528. The software builder server 110 may apply an ML model 522 to the executable elements to generate the scripting language 528. The software builder server 110 may receive feedback from software developers/end users, e.g., a human-in-the loop validation 524, and use the received feedback to determine the scripting language scripting language 528. In some embodiments, the software builder server 110 may access a validated function repository 526 which stores a plurality of pre-generated/validated functions and/or provided by a third party server (e.g., executable-routine-providing server 130). The software builder server 110s select scripting language that can preform the executable routines. The software builder server 110 executes the scripting language 528 at the back-end process 550, and causes the natural-language software builder 112 to display the software program 518 at the front-end process 500.

### Example Dynamic Layout Software Program

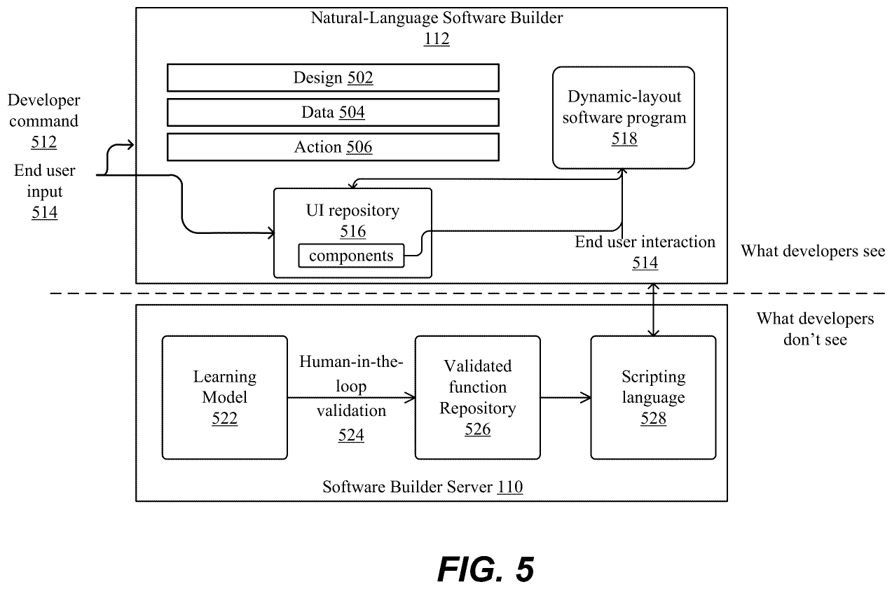

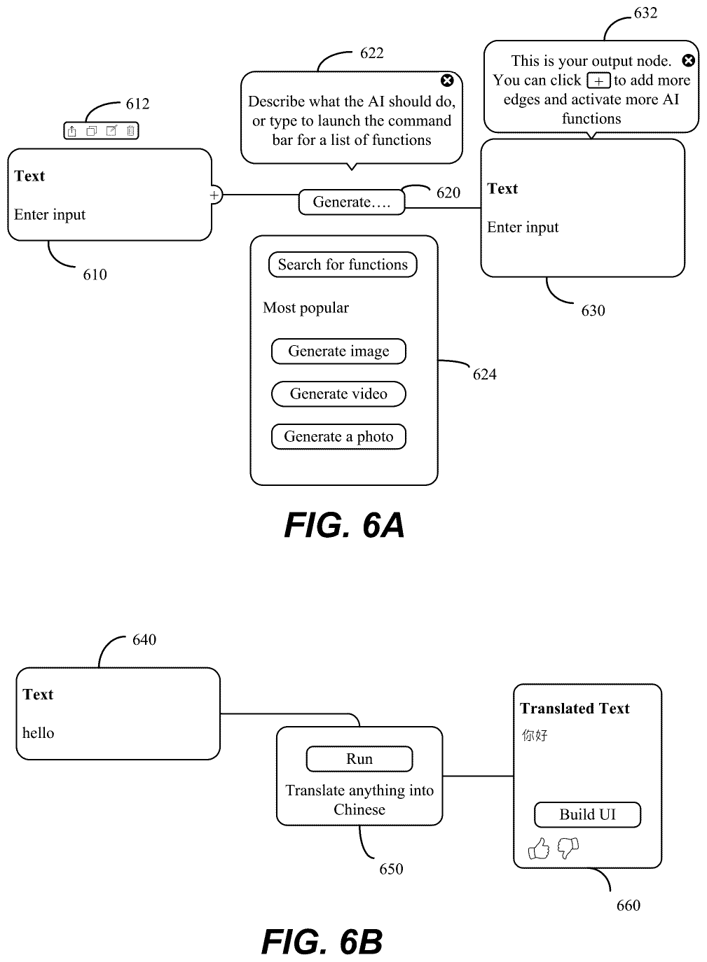

FIGS. 6A and 6B are diagrams illustrating example build interfaces that design a dynamic layout software program during runtime, in accordance with one or more embodiments. The build interfaces shown may be provided by a natural-language software builder 112 that is operated by the software builder server 110. FIG. 6A illustrates a process that a software developer provides instructions on designing the dynamic layout software program via a build interface. As shown in FIG. 6A, the build interface may include various user interface elements that correspond to the nodes (e.g., 610, 630) and edges (e.g., 620) of the dynamic layout software program. For example, the nodes 610 and 630 are connected by an edge 620. The software developer may determine the nodes 610 and 630 as input node and output node of the edge 620, respectively. The node 610 may represent an initial state of the dynamic layout software program for an end user to provide an input. The build interface may include various build interface elements that assist the software developer to build the dynamic layout software program. For example, the build interface element 612 is used to specify the design (e.g., modality, layout, interactive interface, etc.) of the node 610. The build interface element 622 may provide instructions to the software developer for designing the edge 620. In one example, the build interface element 622 may request the software developer to “describe what to do or type to launch the command bar for a list of functions.” The build interface element 624 may provide a function repository and/or an UI repository assisting the software developer in specifying the edge 620. The software developer may describe a desired action/function (e.g., executable routine) in a natural language for the edge 620. For example, the software developer may input “generate . . . ” for the edge 620. The build interface element 624 may search functions based on the input and provide a search result of functions for the software developer to select, e.g., “generate image,” “generate video,” “generate a photo,” etc. The build interface element 624 may rank the search results/functions based on popularity, etc., to assist the software developer in designing the function for the edge 620. The node 630 may be an output node for the edge 620. The node 630 may include one or more layout elements for presenting the result of the execute routine described in the edge 620. The design, data content, layout of the node 630 may be defined by the software developer, and/or depend on the output of the runtime execution of the dynamic layout software program. In some embodiments, the node 630 may be an input node for subsequent edges. As shown in FIG. 6A, the build interface may include a build interface element 632 providing instructions on building subsequent edges based on an output node. The build interface element 632 may request the software developer to interact with the build interface element 632 and add more edges and functions from an output node.

FIG. 6B illustrates an example dynamic layout software program during a runtime execution. As shown in FIG. 6B, the dynamic layout software program includes an input node 640, an output node 660, and an edge 650 connecting the input node 640 and output node 660. The edge 650 represents an executable routine that is specified in a natural language, “Translate anything into Chinese.” The input node 640 receives text signal as input and the output node 660 receives the text signal as an output. During runtime of the dynamic layout software program, in one example, an end user may input “hello” to the input node input node 640 via a dynamic user interface 152 at the end user device 150. Executing the dynamic layout software program with the end user input, the output node 660 may output the translation of “hello” in Chinese. In some embodiments, the output node 660 may include other user interface elements, such as feedback button, interactive elements, etc.

In some embodiments, the software developer may build the dynamic layout software program from a node. For example, the software developer has some specific data content to use or build on, the software developer can start by creating a first input node to receive the data content. The software developer may click on a user interface rendered object, e.g., “+” symbol, to create an edge that uses the node's data content as input and generates new data content from it (when it is executed, e.g., “run”), given a description of the executable routine represented by the edge. In some embodiments, the software developer may build the dynamic layout software program 120 from an edge. For example, the software developer may build a software program to handle a variety of inputs. Instead, the software developer may start building the dynamic layout software program by describing a desired functionality, e.g., image processing, financial analysis, etc. In this case, the input/output nodes for the edge may be automatically created, for example, in a generic mode. The software developer may provide a natural language description of the desired functionality to build an edge and then provide some input to generate the desired output.

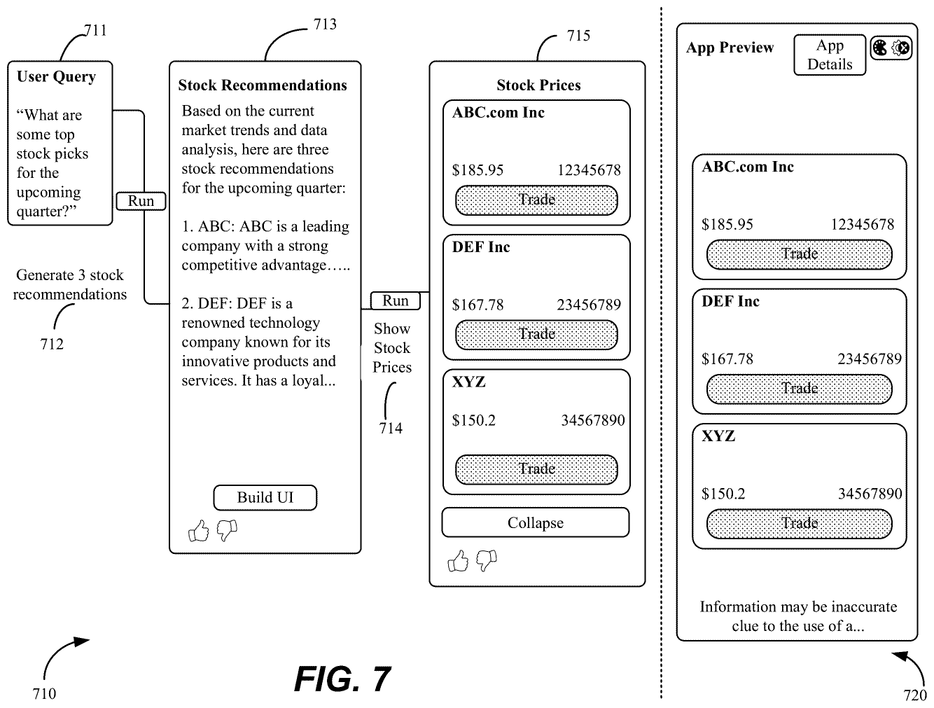

FIG. 7 depicts an example build interface 710 of a dynamic layout software program and the corresponding dynamic user interface 720, in accordance with one or more embodiments. A natural-language software builder provides the build interface 710 for the software developer to design the dynamic layout software program 120. The build interface 710 may be displayed by a software developer device 140 and accessible to the software developer. As shown in FIG. 7, the build interface 710 may include user interface elements that correspond to the nodes (e.g., 711, 713, 715, etc.) and edges (e.g., 712, 714, etc.) of the dynamic layout software program 120. The build interface 710 may include more than one edges that connect a set of nodes. The nodes 711, 713, and 715 may be input nodes or output nodes with respect to each corresponding edge 712 or 714. For example, the edge 712 represents an executable routine specified in a natural language, “generate 3 stock recommendations.” The nodes 711 and 713 are input and output nodes with respect to the edge 712, respectively. The node 711 may represent a state for an end user to provide an input/query, e.g., “what are some top stock picks for the upcoming quarter?” The node 713 may represent a state that display results of the execution of the executable routine represented in the edge 712. In one example, the nodes 713 may present the 3 recommended stocks with their corresponding descriptions. The results may be displayed in a text box in a format of a list in build interface 710 and/or corresponding dynamic user interface 720. In some embodiments, the interface corresponding to the node 713 may include other layout elements, such as feedback buttons, interactive elements, etc.

In FIG. 7, the node 713 is an input node for the edge 714, and the corresponding output node is node 715. The edge 714 represents an executable routine specified in a natural language, “show stock prices.” The node 715 represents a state that display results of the execution of the executable routine represented in the edge 714. In one example, the nodes 715 may present the stock price of each of the 3 recommended stocks in a layout element, e.g., a display card containing requested information. The nodes (e.g., 711, 713, 715, etc.) may be presented with layout elements included in the user interface. The layout elements may be determined based on the software developer's instruction, then end user input, and/or execution of the executable routines (e.g., by using an ML model). In some embodiments, each of the output node in the build interface 710 may include a feedback interactive element. The software developer may provide feedback to the generated output node and the feedback may be used to validate the output node and/or update and re-train the corresponding ML models used to generate the output node.

The dynamic user interface 720 corresponds to a user interface displayed at the end user device 150 during the runtime of the execution of the dynamic layout software program. The dynamic user interface 720 may be similar to the build interface 710, including the same layout elements with the same data content; alternatively, the dynamic user interface 720 may include different layout elements for the end user to provide input, feedback, interactions, and the like. In some implementations, the dynamic user interface 720 may be synchronized with the build interface 710 at each step of the execution of the dynamic layout software program. For example, when the dynamic layout software program executes the function corresponding to the edge 712, the dynamic user interface 720 may display a first user interface that is similar to the interface of node 713; and when the dynamic layout software program executes the function corresponding to the edge 714, the dynamic user interface 720 may be modified to display a second user interface that is similar to the interface of node 715. In some implementations, the dynamic user interface 720 may be configured to show the final results of the dynamic layout software program. For example, after receiving the first end user input, during the runtime of the dynamic-layout software program, the dynamic user interface 720 directly displays the interface corresponding to the node 715, while the build interface 710 proceeds from the nodes 711, 713, and 715, successively.

### Graphs of Dynamic Layout Software Program

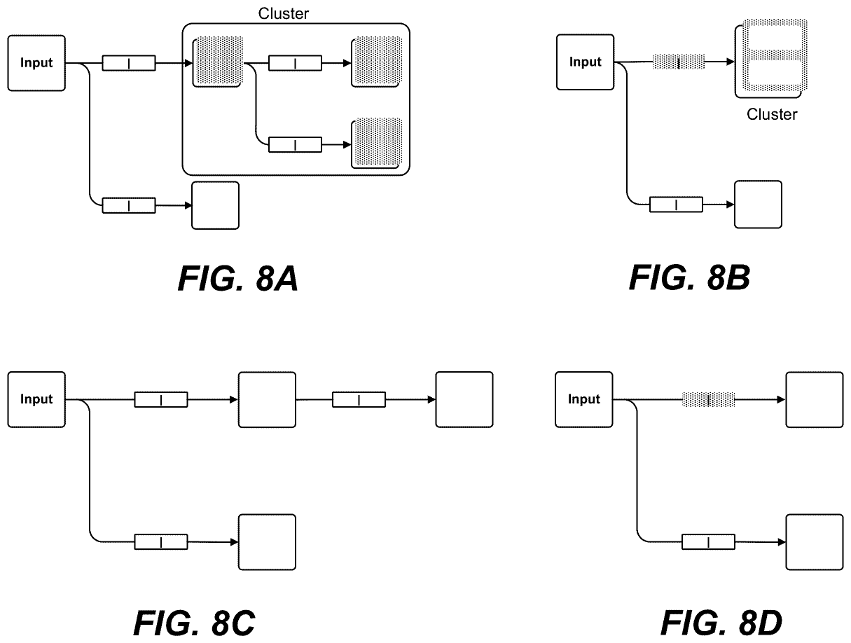

FIGS. 8A-8D are diagrams illustrating example graphs of the dynamic layout software program, in accordance with one or more embodiments. The dynamic layout software program may include one or more sets of nodes and edges, and each set of nodes and edges may be grouped/clustered together to represent a single executable routine that performs combined tasks of all the edges in the cluster. In some embodiments, a software developer may use a cluster of nodes/edges to customize a desired function. The cluster/customized function may be stored and used as a building block for building the dynamic layout software program. The corresponding natural language descriptions may be combined and integrated for the cluster so that the integrated description may be used for the software developer to determine/select the corresponding cluster of nodes and edges.

In some embodiments, the dynamic layout software program may include nodes and edges that are executed in a sequential order; alternatively, the dynamic layout software program may include several chains of the nodes and edges, and each chain may correspond to a set of nodes and edges. In this way, the dynamic layout software program may include a graph of nodes and edges that are combined together to form a dynamic layout software program, as the examples shown in FIGS. 8A-8D. As the nodes and edges may be described in a natural language, a complex task including multiple sub-tasks may be described in a single sentence, the description may be broken into smaller pieces that each describes a sub-task. The software developer may combine the set of sub-tasks to accomplish the complex task, e.g., by building clusters of nodes and edges. In one example, semantic expansion may be applied to the description to determine a set of candidate functions/layout elements for the software developer to select.

In some embodiments, the design of the graph (e.g., the layout elements) may be similar to a single node/edge. A software developer may design an individual node/edge first and then grouping them together to design a more complex layout. When a multi-component dynamic layout software program is built using the described graph of nodes and edges, the graph indicates the execution pipeline of the dynamic layout software program, once the inputs are provided. Since the graph involves chains of nodes/edges, they are executed sequentially along the chain, although different chains may run in parallel. Depending on the length and complexity of the chains and graphs, different parts of the output may be generated at different rates.

### Example Machine-Learning Models

In various embodiments, a wide variety of machine learning techniques may be used. Examples include different forms of reinforcement learning (RL), supervised learning, unsupervised learning, and semi-supervised learning such as decision trees, support vector machines (SVMs), regression, Bayesian networks, and genetic algorithms. Deep learning techniques such as neural networks, including convolutional neural networks (CNN), recurrent neural networks (RNN) and long short-term memory networks (LSTM), may also be used. For example, generating the machine learnable scripting language may be performed by applying a RL, and other processes may apply one or more machine learning and deep learning techniques.

In various embodiments, the training techniques for a machine-learning model may be reinforcement learning (RL), supervised, semi-supervised, or unsupervised. Using RL to generate a scripting language involves training an agent to produce code sequences that connects executable elements and perform execute routines. The process starts with defining an environment where the agent interacts by generating code snippets in a scripting language. The agent begins by exploring different combinations of syntax and commands, receiving feedback through rewards or penalties based on the functionality and correctness of the generated scripting language. For instance, if the goal is to generate a scripting language, when executed, can perform a function corresponding to an executable routine, the agent is rewarded when the scripting language successfully performs the function and penalized for errors or inefficiencies. In some implementations, the RL may include a Q-learning which is a model-free algorithm that learns the value of action-reward pairs (Q-values) without needing a model of the environment. In some implementations, the RL may include policy gradients which is a method that directly adjusts the policy based on the gradient of expected rewards. Over time, through trial and error, the agent learns to optimize its code generation strategy, producing more effective and accurate scripting language. This iterative learning process allows the RL agent to improve continuously, leveraging the reward signals to refine its understanding of the scripting language and its application.

By way of example, the training set may include multiple past records (e.g., scripting language) with known outcomes. Each training sample in the training set may correspond to a past and the corresponding outcome may serve as the label for the sample. A training sample may be represented as a feature vector that include multiple dimensions. Each dimension may include data of a feature, which may be a quantized value of an attribute that describes the past record. For example, in a machine-learning model that is used to generate scripting language that connects the executable elements, the features in a feature vector may include executable elements, such as data signal, display elements, layout parameter, functions corresponding to the executable routines, etc. In various embodiments, certain pre-processing techniques may be used to normalize the values in different dimensions of the feature vector.

In some embodiments, an unsupervised learning technique may be used. The training samples used for an unsupervised model may also be represented by features vectors, but may not be labeled. Various unsupervised learning techniques such as clustering may be used in determining similarities among the feature vectors, thereby categorizing the training samples into different clusters. In some cases, the training may be semi-supervised with a training set having a mix of labeled samples and unlabeled samples.

A machine-learning model may be associated with an objective function, which generates a metric value that describes the objective goal of the training process. The training process may intend to reduce the error rate of the model in generating predictions. In such a case, the objective function may monitor the error rate of the machine-learning model. In a model that generates predictions, the objective function of the machine learning algorithm may be the training error rate when the predictions are compared to the actual labels. Such an objective function may be called a loss function. Other forms of objective functions may also be used, particularly for unsupervised learning models whose error rates are not easily determined due to the lack of labels. In some embodiments, in generating a scripting language that connects the executable elements, the objective function may correspond to feedback from a software developer, and the feedback may indicate a level of satisfaction that the generated scripting language, when executed, performs the functionality of the corresponding executable routine. In various embodiments, the error rate may be measured as cross-entropy loss, L1 loss (e.g., the sum of absolute differences between the predicted values and the actual value), L2 loss (e.g., the sum of squared distances).

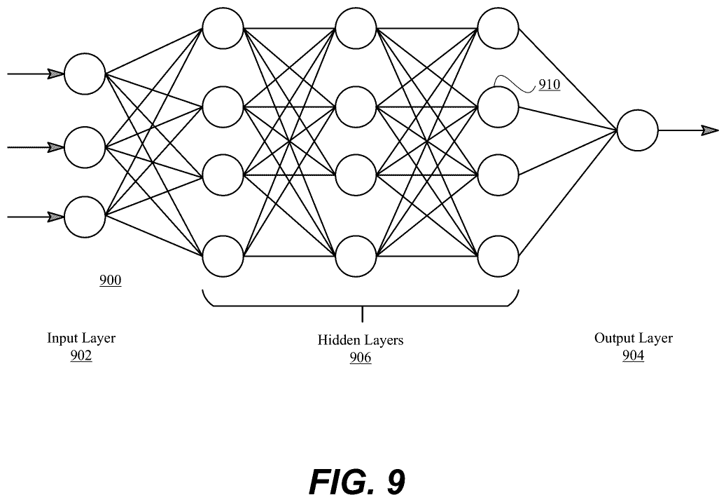

Referring to FIG. 9, a structure of an example neural network is illustrated, in accordance with some embodiments. The neural network 900 may receive an input and generate an output. The input may be the feature vector of a training sample in the training process and the feature vector of an actual case when the neural network is making an inference. The output may be the prediction, classification, or another determination performed by the neural network. The neural network 900 may include different kinds of layers, such as convolutional layers, pooling layers, recurrent layers, fully connected layers, and custom layers. A convolutional layer convolves the input of the layer (e.g., an image) with one or more kernels to generate different types of images that are filtered by the kernels to generate feature maps. Each convolution result may be associated with an activation function. A convolutional layer may be followed by a pooling layer that selects the maximum value (max pooling) or average value (average pooling) from the portion of the input covered by the kernel size. The pooling layer reduces the spatial size of the extracted features. In some embodiments, a pair of convolutional layer and pooling layer may be followed by a recurrent layer that includes one or more feedback loops. The feedback may be used to account for spatial relationships of the features in an image or temporal relationships of the objects in the image. The layers may be followed by multiple fully connected layers that have nodes connected to each other. The fully connected layers may be used for classification and object detection. In one embodiment, one or more custom layers may also be presented for the generation of a specific format of the output. For example, a custom layer may be used for image segmentation for labeling pixels of an image input with different segment labels.

The order of layers and the number of layers of the neural network 900 may vary in different embodiments. In various embodiments, a neural network 900 includes one or more layers 902, 904, and 906, but may or may not include any pooling layer or recurrent layer. If a pooling layer is present, not all convolutional layers are always followed by a pooling layer. A recurrent layer may also be positioned differently at other locations of the CNN. For each convolutional layer, the sizes of kernels (e.g., 3×3, 5×5, 7×7, etc.) and the numbers of kernels allowed to be learned may be different from other convolutional layers.

A machine-learning model may include certain layers, nodes 910, kernels and/or coefficients. Training of a neural network, such as the NN 900, may include forward propagation and backpropagation. Each layer in a neural network may include one or more nodes, which may be fully or partially connected to other nodes in adjacent layers. In forward propagation, the neural network performs the computation in the forward direction based on the outputs of a preceding layer. The operation of a node may be defined by one or more functions. The functions that define the operation of a node may include various computation operations such as convolution of data with one or more kernels, pooling, recurrent loop in RNN, various gates in LSTM, etc. The functions may also include an activation function that adjusts the weight of the output of the node. Nodes in different layers may be associated with different functions.

Training of a machine-learning model may include an iterative process that includes iterations of making determinations, monitoring the performance of the machine-learning model using the objective function, and backpropagation to adjust the weights (e.g., weights, kernel values, coefficients) in various nodes 910. For example, a computing device may receive a training set that includes scripting language and natural language description of executable elements. Each training sample in the training set may be assigned with labels indicating whether a scripting language when executed, can or cannot perform the functionality of the respective executable routine. The computing device, in a forward propagation, may use the machine-learning model to generate predicted scripting language. The computing device may compare the predicted scripting language with the labels of the training sample. The computing device may adjust, in a backpropagation, the weights of the machine-learning model based on the comparison. The computing device backpropagates one or more error terms obtained from one or more loss functions to update a set of parameters of the machine-learning model. The backpropagating may be performed through the machine-learning model and one or more of the error terms based on a difference between a label in the training sample and the generated predicted value by the machine-learning model.

By way of example, each of the functions in the neural network may be associated with different coefficients (e.g., weights and kernel coefficients) that are adjustable during training. In addition, some of the nodes in a neural network may also be associated with an activation function that decides the weight of the output of the node in forward propagation. Common activation functions may include step functions, linear functions, sigmoid functions, hyperbolic tangent functions (tanh), and rectified linear unit functions (ReLU). After an input is provided into the neural network and passes through a neural network in the forward direction, the results may be compared to the training labels or other values in the training set to determine the neural network's performance. The process of prediction may be repeated for other samples in the training sets to compute the value of the objective function in a particular training round. In turn, the neural network performs backpropagation by using gradient descent such as stochastic gradient descent (SGD) to adjust the coefficients in various functions to improve the value of the objective function.

Multiple rounds of forward propagation and backpropagation may be performed. Training may be completed when the objective function has become sufficiently stable (e.g., the machine-learning model has converged) or after a predetermined number of rounds for a particular set of training samples. The trained machine-learning model can be used for generating scripting language or another suitable task for which the model is trained.

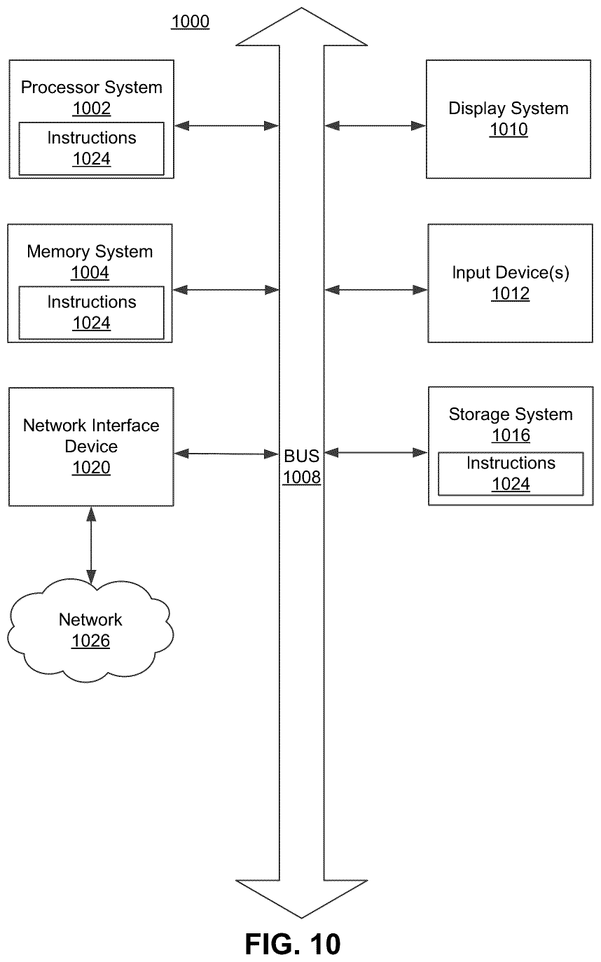

Turning now to FIG. 10, illustrated is an example machine to read and execute computer readable instructions, in accordance with an embodiment. Specifically, FIG. 10 shows a diagrammatic representation of the data processing service 102 (and/or data processing system) in the example form of a computer system 1000. The computer system 1000 is structured and configured to operate through one or more other systems (or subsystems) as described herein. The computer system 1000 can be used to execute instructions 1024 (e.g., program code or software) for causing the machine (or some or all of the components thereof) to perform any one or more of the methodologies (or processes) described herein. In executing the instructions, the computer system 1000 operates in a specific manner as per the functionality described. The computer system 1000 may operate as a standalone device or a connected (e.g., networked) device that connects to other machines. In a networked deployment, the machine may operate in the capacity of a server machine or a client machine in a server-client network environment, or as a peer machine in a peer-to-peer (or distributed) network environment.

The computer system 1000 may be a server computer, a client computer, a personal computer (PC), a tablet PC, a smartphone, an internet of things (IoT) appliance, a network router, switch or bridge, or other machine capable of executing instructions 1024 (sequential or otherwise) that enable actions as set forth by the instructions 1024. Further, while only a single machine is illustrated, the term “machine” shall also be taken to include any collection of machines that individually or jointly execute instructions 1024 to perform any one or more of the methodologies discussed herein.

The example computer system 700 includes a processing system 1002. The processor system 1002 includes one or more processors. The processor system 1002 may include, for example, a central processing unit (CPU), a graphics processing unit (GPU), a digital signal processor (DSP), a controller, a state machine, one or more application specific integrated circuits (ASICs), one or more radio-frequency integrated circuits (RFICs), or any combination of these. The processor system 1002 executes an operating system for the computing system 1000. The computer system 1000 also includes a memory system 1004. The memory system 1004 may include or more memories (e.g., dynamic random access memory (RAM), static RAM, cache memory). The computer system 1000 may include a storage system 1016 that includes one or more machine readable storage devices (e.g., magnetic disk drive, optical disk drive, solid state memory disk drive).

The storage unit 1016 stores instructions 1024 (e.g., software) embodying any one or more of the methodologies or functions described herein. For example, the instructions 724 may include instructions for implementing the functionalities of the transaction module 330 and/or the file management module 335. The instructions 1024 may also reside, completely or at least partially, within the memory system 1004 or within the processing system 1002 (e.g., within a processor cache memory) during execution thereof by the computer system 700, the main memory 1004 and the processor system 1002 also constituting machine-readable media. The instructions 1024 may be transmitted or received over a network 1026, such as the network 1026, via the network interface device 1020.

The storage system 1016 should be taken to include a single medium or multiple media (e.g., a centralized or distributed database, or associated caches and servers communicatively coupled through the network interface system 1020) able to store the instructions 1024. The term “machine-readable medium” shall also be taken to include any medium that is capable of storing instructions 1024 for execution by the machine and that cause the machine to perform any one or more of the methodologies disclosed herein. The term “machine-readable medium” includes, but not be limited to, data repositories in the form of solid-state memories, optical media, and magnetic media.

In addition, the computer system 1000 can include a display system 1010. The display system 1010 may driver firmware (or code) to enable rendering on one or more visual devices, e.g., drive a plasma display panel (PDP), a liquid crystal display (LCD), or a projector. The computer system 1000 also may include one or more input/output systems 1012. The input/output (IO) systems 1012 may include input devices (e.g., a keyboard, mouse (or trackpad), a pen (or stylus), microphone) or output devices (e.g., a speaker). The computer system 1000 also may include a network interface system 1020. The network interface system 1020 may include one or more network devices that are configured to communicate with an external network 1026. The external network 1026 may be a wired (e.g., ethernet) or wireless (e.g., WiFi, BLUETOOTH, near field communication (NFC).

The processor system 1002, the memory system 1004, the storage system 1016, the display system 1010, the IO systems 1012, and the network interface system 1020 are communicatively coupled via a computing bus 1008.

### ADDITIONAL CONSIDERATIONS

The foregoing description of the embodiments has been presented for the purpose of illustration; it is not intended to be exhaustive or to limit the patent rights to the precise forms disclosed. Persons skilled in the relevant art can appreciate that many modifications and variations are possible in light of the above disclosure.

Embodiments according to the invention are in particular disclosed in the attached claims directed to a method and a computer program product, wherein any feature mentioned in one claim category, e.g. method, can be claimed in another claim category, e.g. computer program product, system, storage medium, as well. The dependencies or references back in the attached claims are chosen for formal reasons only. However, any subject matter resulting from a deliberate reference back to any previous claims (in particular multiple dependencies) can be claimed as well, so that any combination of claims and the features thereof is disclosed and can be claimed regardless of the dependencies chosen in the attached claims. The subject-matter which can be claimed comprises not only the combinations of features as set out in the disclosed embodiments but also any other combination of features from different embodiments. Various features mentioned in the different embodiments can be combined with explicit mentioning of such combination or arrangement in an example embodiment. Furthermore, any of the embodiments and features described or depicted herein can be claimed in a separate claim and/or in any combination with any embodiment or feature described or depicted herein or with any of the features.

Some portions of this description describe the embodiments in terms of algorithms and symbolic representations of operations on information. These operations and algorithmic descriptions, while described functionally, computationally, or logically, are understood to be implemented by computer programs or equivalent electrical circuits, microcode, or the like. Furthermore, it has also proven convenient at times, to refer to these arrangements of operations as engines, without loss of generality. The described operations and their associated engines may be embodied in software, firmware, hardware, or any combinations thereof.

Any of the steps, operations, or processes described herein may be performed or implemented with one or more hardware or software engines, alone or in combination with other devices. In one embodiment, a software engine is implemented with a computer program product comprising a computer-readable medium containing computer program code, which can be executed by a computer processor for performing any or all of the steps, operations, or processes described. The term “steps” does not mandate or imply a particular order. For example, while this disclosure may describe a process that includes multiple steps sequentially with arrows present in a flowchart, the steps in the process do not need to be performed by the specific order claimed or described in the disclosure. Some steps may be performed before others even though the other steps are claimed or described first in this disclosure.

Throughout this specification, plural instances may implement components, operations, or structures described as a single instance. Although individual operations of one or more methods are illustrated and described as separate operations, one or more of the individual operations may be performed concurrently, and nothing requires that the operations be performed in the order illustrated. Structures and functionality presented as separate components in example configurations may be implemented as a combined structure or component. Similarly, structures and functionality presented as a single component may be implemented as separate components. These and other variations, modifications, additions, and improvements fall within the scope of the subject matter herein. In addition, the term “each” used in the specification and claims does not imply that every or all elements in a group need to fit the description associated with the term “each.” For example, “each member is associated with element A” does not imply that all members are associated with an element A. Instead, the term “each” only implies that a member (of some of the members), in a singular form, is associated with an element A.

Finally, the language used in the specification has been principally selected for readability and instructional purposes, and it may not have been selected to delineate or circumscribe the patent rights. It is therefore intended that the scope of the patent rights be limited not by this detailed description, but rather by any claims that issue on an application based hereon. Accordingly, the disclosure of the embodiments is intended to be illustrative, but not limiting, of the scope of the patent rights.

What is claimed is:

1. A system comprising:
a natural-language software builder configured to display a build interface that allows a software developer to design a dynamic-layout software program that is represented by nodes and one or more edges, at least one node representing an initial state for an end user to provide an input and at least one edge representing an executable routine whose functionality is specified in a natural language by the software developer; and
a computing server in communication with the natural language software builder, the computing server comprising one or more processors and memory configured to store code comprising instructions, wherein the instructions, when executed by the one or more processors, cause the one or more processors to:
receive the nodes and edges representing the dynamic-layout software program;
execute, at runtime of the dynamic-layout software program, the initial state of the dynamic-layout software program;
receive the input from the end user directed at the dynamic-layout software program;
extract executable elements of the dynamic-layout software program, the executable elements comprising the input and the executable routine specified in one of edges;
apply a machine-learning model to analyze the executable elements to generate, during the runtime of the dynamic-layout software program, a machine-learnable scripting language that connects the executable elements, the machine-learnable scripting language comprising runtime layout parameters of the dynamic-layout software program;
execute the machine-learnable scripting language to cause the dynamic-layout software program to display one or more runtime-determined layout elements.

2. The system of claim 1, wherein the instruction to apply a machine-learning model to analyze the executable elements comprises instructions to:
generate an input to the machine-learning model, the input comprising the executed elements and a request to perform the functionality of the executable routine specified in the one of edges; and
receive an output from the machine-learning model, the output comprising the generated machine-learnable scripting language that when executed, performs the functionality of the executable routine specified in the one of edges.

3. The system of claim 1, wherein the instruction to apply a machine-learning model to analyze the executable elements comprises instructions to:
access a database comprising a plurality of scripting languages, each scripting language corresponding to at least one executable routine; and
determine the machine-learnable scripting language from the plurality of scripting languages based at least on the natural language used to describe the executable routine specified in the one of edges.

4. The system of claim 1, wherein the instruction to extract executable elements comprises instructions to:
apply a natural language processing model to the input from the end user and the executable routine specified in the one of edges.

5. The system of claim 1, wherein the instructions, when executed by the one or more processors, further cause the one or more processors to:
receive, from the software developer, feedback on the runtime-determined layout elements; and
finetune, based on the feedback, the machine-learning model.

6. The system of claim 1, wherein the one or more runtime-determined layout elements vary based on the input from the end user.

7. The system of claim 1, wherein the dynamic-layout software program comprises a set of nodes and edges forming a cluster that represents a customized function.

8. A computer-implemented method, comprising:
receiving nodes and edges representing a dynamic-layout software program, wherein the dynamic-layout software program is represented by the nodes and edges, at least one node representing an initial state for an end user to provide an input and at least one edge representing an executable routine whose functionality is specified in a natural language by a software developer;
executing, at runtime of the dynamic-layout software program, the initial state of the dynamic-layout software program;
receiving the input from the end user directed at the dynamic-layout software program;
extracting executable elements of the dynamic-layout software program, the executable elements comprising the input and the executable routine specified in one of edges;
applying a machine-learning model to analyze the executable elements to generate, during the runtime of the dynamic-layout software program, a machine-learnable scripting language that connects the executable elements, the machine-learnable scripting language comprising runtime layout parameters of the dynamic-layout software program; and
execute the machine-learnable scripting language to cause the dynamic-layout software program to display one or more runtime-determined layout elements.

9. The computer-implemented method of claim 8, wherein applying a machine-learning model to analyze the executable elements comprises:
generating an input to the machine-learning model, the input comprising the executed elements and a request to perform the functionality of the executable routine specified in the one of edges; and
receiving an output from the machine-learning model, the output comprising the generated machine-learnable scripting language that when executed, performs the functionality of the executable routine specified in the one of edges.

10. The computer-implemented method of claim 8, wherein applying a machine-learning model to analyze the executable elements comprises:
accessing a database comprising a plurality of scripting languages, each scripting language corresponding to at least one executable routine; and
determining the machine-learnable scripting language from the plurality of scripting languages based at least on the natural language used to describe the executable routine specified in the one of edges.

11. The computer-implemented method of claim 8, wherein extracting executable elements of the dynamic-layout software program comprises:
applying a natural language processing model to the input from the end user and the executable routine specified in the one of edges.

12. The computer-implemented method of claim 8, further comprising:
receiving, from the software developer, feedback on the runtime-determined layout elements; and
finetuning, based on the feedback, the machine-learning model.

13. The computer-implemented method of claim 8, wherein the one or more runtime-determined layout elements vary based on the input from the end user.

14. The computer-implemented method of claim 8, wherein the dynamic-layout software program comprises a set of nodes and edges forming a cluster that represents a customized function.

15. A non-transitory computer readable storage medium comprising stored program code, the program code comprising instructions, the instructions when executed causes a processor system to:
receive nodes and edges representing a dynamic-layout software program, wherein the dynamic-layout software program is represented by the nodes and edges, at least one node representing an initial state for an end user to provide an input and at least one edge representing an executable routine whose functionality is specified in a natural language by a software developer;
execute, at runtime of the dynamic-layout software program, the initial state of the dynamic-layout software program;
receive the input from the end user directed at the dynamic-layout software program;
extract executable elements of the dynamic-layout software program, the executable elements comprising the input and the executable routine specified in one of edges;
apply a machine-learning model to analyze the executable elements to generate, during the runtime of the dynamic-layout software program, a machine-learnable scripting language that connects the executable elements, the machine-learnable scripting language comprising runtime layout parameters of the dynamic-layout software program;
execute the machine-learnable scripting language to cause the dynamic-layout software program to display one or more runtime-determined layout elements.

16. The non-transitory computer readable storage medium of claim 15, wherein the instruction to apply a machine-learning model to analyze the executable elements, when executed, causes the processor system to:
generate an input to the machine-learning model, the input comprising the executed elements and a request to perform the functionality of the executable routine specified in the one of edges; and
receive an output from the machine-learning model, the output comprising the generated machine-learnable scripting language that when executed, performs the functionality of the executable routine specified in the one of edges.

17. The non-transitory computer readable storage medium of claim 15, wherein the instruction to apply a machine-learning model to analyze the executable elements comprises instructions to:
access a database comprising a plurality of scripting languages, each scripting language corresponding to at least one executable routine; and
determine the machine-learnable scripting language from the plurality of scripting languages based at least on the natural language used to describe the executable routine specified in the one of edges.

18. The non-transitory computer readable storage medium of claim 15, wherein the instruction to extract executable elements comprises instructions to:
apply a natural language processing model to the input from the end user and the executable routine specified in the one of edges.

19. The non-transitory computer readable storage medium of claim 15, wherein the instructions, when executed, further cause the process system to:
receive, from the software developer, feedback on the runtime-determined layout elements; and
finetune, based on the feedback, the machine-learning model.

20. The non-transitory computer readable storage medium of claim 15, wherein the dynamic-layout software program comprises a set of nodes and edges forming a cluster that represents a customized function.
